(19) United States
(12) Patent Application Publication
(10) Pub. No.: US 2026/0320474 A1
(43) Pub. Date: Oct. 15, 2026

(54) Machine-Learned Systems and Methods for Event Analysis

(71) Applicant: Google LLC, Mountain View, CA (US)

(72) Inventors: Brian Harris Kravitz, New York, NY (US); Zigmars Rasscevskis, Zürich (CH); Szabolcs Payrits, Zugerberg (CH)

(21) Appl. No.: 19/174,631

(22) Filed: Apr. 9, 2025

(51) Int. Cl. G06N 20/00

(52) U.S. Cl. CPC G06N 20/00

(57) ABSTRACT

Aspects of the disclosed technology include computer-implemented systems and methods for utilizing specialized machine-learned sequence processing models to automate event analysis of an event's impact on an entity. The system can include a machine-learned system including models for generating hypothesis data based on event and entity data, generating background data, generating argumentation data including quantitative projections based on the hypothesis data and background data, and generating conclusion data based on synthesizing hypotheses and argumentation data.

### FIELD

The present disclosure relates generally to machine learning processes and machine-learned devices and systems. More particularly, the present disclosure relates to generative machine-learned models and systems for performing event analysis.

### BACKGROUND

Artificial intelligence systems increasingly include large foundational machine-learned models which have the capability to provide a wide range of new product experiences. Event analysis relies on understanding the impact of events on target entities and related processes traditionally involve manual reviewing news sources, sifting through articles, formulating hypotheses, identifying pertinent facts, conducting background research, and synthesizing gathered information.

Current general-purpose large language models (LLMs) fall short in addressing the challenges with automation of event analysis. These models are typically designed for conciseness and lack the capacity for in-depth background research necessary for rigorous event analysis. They struggle to understand the nuances of an analyst's specific objectives and lack access to data sources crucial for real-world analysis. Moreover, these LLMs often provide broad, non-committal conclusions, avoiding the decisive insights needed for informed decision-making.

These shortcomings in the existing art highlight the unmet need for a system that can automate and enhance the event analysis process, providing deeper insights, incorporating user-specific goals, and delivering more definitive conclusions.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method that includes, by one or more processors, generating, with a machine-learned hypothesis generation model and based on at least one input including an indication of an event and retrieved background information associated with an entity, hypothesis data based on a pairing of the event and the entity, generating, with a machine-learned question generation model and based on at least one input including the indication of the event and the hypothesis data, background data associated with proof of at least one hypotheses, generating, with a machine-learned quantitative argumentation model, argumentation data based at least in part on the background data, and generating, with a machine-learned conclusion synthesis model and based on the at least one hypotheses, the background data, and the argumentation data, conclusion data including a representation of an analysis of an impact of the event on the entity.

Another example aspect of the present disclosure is directed to a system that includes a machine-learned hypothesis generation model configured to generate hypothesis data based at least in part on an indication of an event, a machine-learned question generation model configured to generate background data based at least in part on an indication of the event and the hypothesis data, a machine-learned quantitative argumentation model configured to generate argumentation data based at least in part on the background data and at least one hypotheses, and a machine-learned synthesis model configured to synthesize the at least one hypotheses, the background data, and the argumentation data into at least one conclusion of an impact of the event.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including an event analysis system according to example embodiments of the present disclosure;

FIG. 2 is a block diagram depicting an example computing environment including an event analysis system and an example data flow for analyzing an impact of an event of an entity using an example event analysis system;

FIG. 3 is a block diagram depicting an example computing environment including training of a machine learning system according to example embodiments of the present disclosure;

FIG. 4 is a flowchart diagram depicting an example method for analyzing the impact of an event on an entity according to example embodiments of the present disclosure;

FIG. 5 is a flow chart diagram depicting an example method for training a machine-learned model according to example implementations of aspects of the present disclosure;

FIG. 6 is a block diagram of an example processing flow for using machine-learned model(s) to process input(s) to generate output(s) according to example embodiments of the present disclosure;

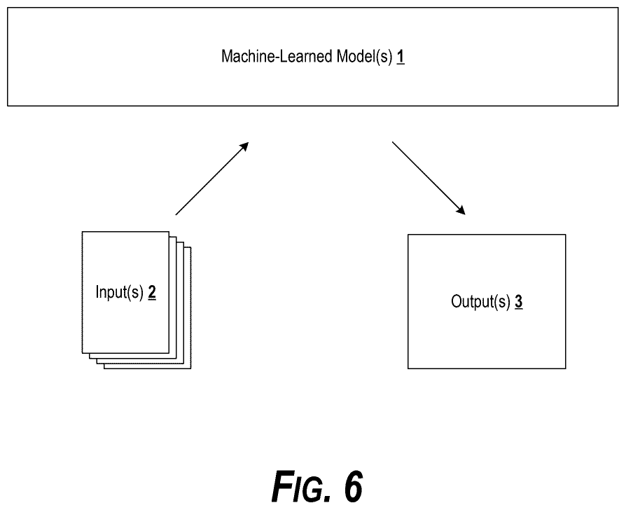

FIG. 7 is a block diagram of an example sequence processing model according to example embodiments of the present disclosure;

FIG. 8 is a block diagram of an example technique for populating an example input sequence for processing by a sequence processing model according to example embodiments of the present disclosure;

FIG. 9 is a block diagram of an example model development platform according to example embodiments of the present disclosure;

FIG. 10 is a block diagram of an example training workflow for training a machine-learned model according to example embodiments of the present disclosure;

FIG. 11 is a block diagram of an inference system for operating one or more machine-learned model(s) to perform inference according to example embodiments of the present disclosure;

FIG. 12 is a block diagram of an example networked computing system according to example embodiments of the present disclosure;

FIG. 13 is a block diagram of an example computing device according to example embodiments of the present disclosure; and

FIG. 14 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Systems and methods in accordance with embodiments of the present disclosure are directed to computing systems and methods for analyzing the impact of events on entities and generating conclusions associated with the impacts. More particularly, embodiments in accordance with the present disclosure are directed to an event analysis machine-learning system having a set of machine-learned models that are accessed (e.g., sequentially or in parallel) to generate hypotheses based on an event and an entity pair, conduct background research and generate background data associated with the entity and/or event, perform quantitative argumentation of findings based on the background data and one or more hypotheses, and synthesize the hypotheses data, background data, and argumentation data into one or more conclusions based upon the sequential research. The machine-learning system can include a set of sequence processing models such as large-language models (LLMs) that perform one or more of a set of tasks for analyzing the impact of an event on a entity. The system can use specialized models (e.g., a fine-tuned LLM) and/or non-specialized models (e.g., a foundational LLM). Each sequence processing model can be trained with training data that is based on demonstrations of one or more tasks performed by the model. In example embodiments, supervised fine-tuning and/or other training techniques can be used. In some examples, one or more of the models can optionally be trained using reinforcement learning based on human feedback to the output of the model and/or using other training techniques. The human feedback can be based on a rating scale that is designed to reflect the utility and quality of outputs generated by each model for a corresponding task. The machine-learning system can reduce computer processing time or other computing resources associated with traditional event analysis.

Event analysis has traditionally relied on human-driven processes that make use of various computing systems to provide an analysis of the impact of an event on an entity. Traditional analysis has been done with human reasoning, though models such as large language models may be used with manual prompts. Knowledge workers, for example, in roles such as computer system analysis, business to business (B2B) sales, product strategy, technology and consulting can spend substantial time researching and analyzing business events, using computing resources to understand their impact on target companies. This traditional process involves, for example, retrieving news sources, sifting through articles, hypothesizing potential impacts, identifying relevant facts, conducting background research, and synthesizing the gathered information. Such an approach suffers from several shortcomings, including an iterative manual-driven process that is time-consuming and error-prone, and requires knowledge of the analyst's purpose. Moreover, this process consumes substantial computing resources such as power, bandwidth, processing capacity, and the like due to the volume of information that must be retrieved and processed.

Consider an example event analysis of an event such as a computing manufacturer entering a computer chip market (e.g., graphical processing units (GPU)). More particularly, an event analysis may include analyzing the impacts on an existing manufacturer of the new computing manufacturer entering the computer chip market. A knowledge worker analyzing such events may utilize and/or access multiple computing systems as part of a cycle of analyzing the impact of the event. The knowledge worker may perform a cycle that includes retrieving news sources for news relating to the target company, its competitors, and the overall industry. The worker may sift through such sources using various computing systems to read or otherwise consume content. The worker may hypothesize potential impacts of the event such as that the chips from the new manufacturer will impact the existing manufacturer by some unknown amount. The worker may identify relevant information or facts about the event and the event impact by accessing one or more computing systems, a data store, an external service, or the like. For example, the worker may seek to identify what are the capabilities and limitations of a new chip from the new manufacturer and what are the capabilities and limitations of existing chips of the existing company. The worker may seek to identify what is the roadmap for the emerging computer chips and existing computer chips, do the customer bases overlap, are they likely to overlap in the future and why, what are customers opinions of both chips, what are their respective customer populations, do both companies sell to the same market, what are the overall computer chip trends across the world, what are the competitive computer chip trends, and the like, do sales of chip fabrication equipment to chip customers, and what are the business drivers for the future expansion of the chips. The worker may conduct background research to gather additional information and facts relating to these questions. This process can involve extensive reading across a wide range of resources such as news sources, web sites, government documents, and corporate publications. The worker may combine many different information sources into evidence to understand and substantiate what the impacts may be.

These existing processes have many limitations. For example, they are time consuming and laborious and require substantial amounts of computer resources such as power, bandwidth, processor speeds, and the like, due to the volume of information that must be retrieved and processed. Moreover, doing so properly not only relies on external information about the events and entities in question, but also on the analyst's purpose in doing the analysis. This process is error prone and time consuming and requires the analyst to conduct manual research and synthesize the gathered information. Moreover, general purpose LLMs are not designed to perform in-depth event analysis. The focus of such LLMs is on conciseness and a lack of deep background research capabilities, and lack of access to paid data sources. Moreover, they do not account for the analyst's purpose, and lack human-readable analysis capabilities.

The present disclosure describes a machine-learning system that automates the analysis of the impact of an event on an entity using specialized sequence processing models such as large language models (LLMs). The event analysis machine-learning system implements a process flow for analyzing impact(s) of an event on an entity. The process flow can include accessing a set of machine-learned sequence processing models to generate hypotheses, formulate background research questions, conduct background research, quantitatively analyze findings, use quantitative projections to validate hypotheses, and synthesize the results. The system can formulate predictions or hypotheses regarding the impact of an event based on an event/entity pair and retrieved background information specific to the event/entity pair. The system can formulate specific background research questions based on the event and the hypotheses. The background research questions can be designed to enable proving or disproving the validity of hypotheses generated by the LLMs. The system can conduct background research to gather facts relevant to the background questions using one or more computing systems such as public data sources like, for example, web, government filings, etc. The system can generate background data based on the background research. The system can quantitatively analyze findings based on facts derived from the background research. The system can generate argumentation data based on the quantitative analysis. The system can use quantitative projections to support the most likely hypotheses. The system can synthesize the hypotheses, background research, and argumentation data to generate one or more conclusions based on the research. In an example implementation, a set of “focus areas” can be input to inform the system of its specific research goals. For example, a user may enter a set of focus areas that describe research goals, the researcher's position, etc., or other information so that the system understands the purpose of the research and can adapt intermediate outputs.

In accordance with an example implementation, the machine-learning system can include particular sequence processing models that are configured for one or more tasks associated with the process flow. For example, the machine-learning system can include a hypothesis generation model that is configured to generate hypotheses based on an event and entity. The machine-learning system can include a question generation model that is configured to generate background data based on the event and hypotheses. The machine-learning system can include a quantitative argumentation model that is configured to generate quantitative argumentation data based on one or more hypotheses and the background data. The machine-learning system can include a machine-learned conclusion synthesis model that is configured to synthesize the hypotheses, background data, and the argumentation data into one or more conclusions based upon the research. One or more of the models can be trained using supervised fine-tuning based on human demonstrations of the task performed by the model or other training and specialization techniques. One or more of the models also can additionally be trained using reinforcement learning based on human feedback to a respective output of the model or other non-RLHF techniques. The reinforcement learning using human feedback can be based on a rating scale that is designed to reflect the utility and quality of outputs generated by each model for a corresponding task.

Systems and methods in accordance with example embodiments provide a number of technical effects and benefits, particularly to computing systems. For example, systems and methods in accordance with embodiments of the present disclosure enable a computing system to reduce computer processing time or other computing resources associated with traditional event analysis. In some examples, a computing system can perform an event analysis by performing data retrieval from one or more computing systems, processing such retrieved data, synthesizing the processed data, and outputting the processed data. A computing system performing this method eliminates the need for human intervention and for manually performing the analysis to determine the impact of an event on an entity.

The disclosed system also provides a number of technical effects and benefits relative to existing machine-learning systems for event analysis. For example, an event analysis machine-learning system in accordance with examples of the present disclosure can use particular sequence processing models that are configured for one or more respective tasks associated with an event analysis process. For example, a machine-learning system in accordance with the present disclosure can use a particular hypothesis generation model, a particular question generation model, a particular argumentation model, a particular synthesis model, and the like. Each machine-learned model can be trained using supervised fine-tuning, reinforcement learning from human feedback, and/or other techniques. In this manner, a machine-learning system in accordance with the present disclosure can more efficiently and accurately perform an event analysis task. A machine-learning system in accordance with examples of the present disclosure can reduce computer processing time, power, and other resources that other computing systems consume in performing the analysis.

In example implementations, the generative models can include sequence processing models such as large language models (LLM). Much of the following disclosure refers to large language models as specific examples of generative models but it will be appreciated that the disclosure is equally applicable to any type of generative model such as other sequence processing models. For example, the disclosed technology can be used with large image models, multimodal models, and other types of foundational models. For instance, the generative models can operate in domains other than the text domain, such as image domains, audio domains, biochemical domains, etc. For instance, a sequence processing model may be used to process sequential inputs for robotic controls and other tasks. Similarly, the generative model and/or the downstream applications can be configured to perform any number of tasks. For instance, if the inputs to the generative model and/or a downstream application are images or features that have been extracted from images, the output generated by the generative model for a given image can be scores for each of a set of object categories, with each score representing an estimated likelihood that the image contains an image of an object belonging to the category. As another example, if the inputs to the generative model and/or a downstream application are sensor data, the outputs can be robotic control signals.

Although a number of examples of tasks which may be performed by the generative model and/or a downstream application are provided here, it will be understood that this is not exhaustive, and that the generative model and/or the downstream applications can be configured to perform any suitable task.

With reference now to the Figures, example embodiments of the present disclosure will be discussed in further detail.

### Example System Arrangements

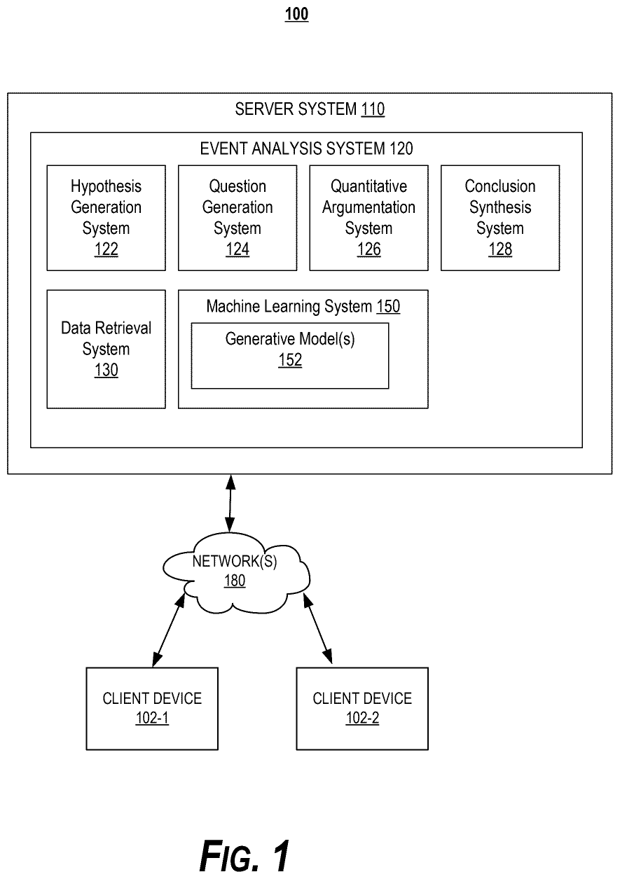

FIG. 1 depicts an example computing environment including an event analysis system according to example embodiments of the present disclosure. More particularly, FIG. 1 illustrates a computing environment 100 including a server system 110 having an event analysis system 120, and a plurality of client devices, such as client device 102-1 and client device 102-2. The event analysis system 120 includes a machine-learned hypothesis generation system 122, a machine-learned question generation system 124, a machine-learned quantitative argumentation system 126, a machine-learned conclusion synthesis system 128, a data retrieval system 130, and a machine-learning system 150 having one or more machine-learned generative models 152. Event analysis system 120 is configured to generate one or more hypotheses based on an event and entity, and generate one or more conclusions based on the one or more hypotheses, one or more background requests, and one or more argumentation processes.

In some examples, server system 110 may be implemented by a first computing system and each of the client devices 102 can be implemented by different remote computing systems. For instance, computing environment 100 may be implemented as a client server computing environment, including one or more client computing devices implementing downstream applications and one or more server computing systems implementing server system 110. In another example, server system 110 can be accessed by one or more remote server systems in addition to or in place of client devices 102.

The computing systems implementing server system 110 and client devices 102 can be connected by and communicate through one or more networks 180. Any number of client computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a client computing device implementing a downstream application can be any suitable device, including, but not limited to, a smartphone, a tablet, a laptop, a desktop computer, or any other computer device that is configured such that it can allow a user to access remote computing devices over a network. The client computing devices can include one or more processor(s), memory, and a display as described in more detail hereinafter. The client computing devices can execute one or more client applications such as a web browser, email application, chat application, video conferencing application, word processing application or the like.

The server system 110 can include one or more processor(s) and memory. The server computing system can be in communication with the one or more client computing device(s) using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

In various examples, server system 110 can implement one or more cloud computing services, an email service, a videoconference service, or other hosted service that utilizes the server system 110 to store data, code, and the like that can be accessed by client devices. Server system 110 can implement one or more hosted applications that provide access to data stored in the storage domains.

Generative models 152 can include any type of machine-learned generative model. In an example, a generative model can include a sequence processing model such as a large language model including 10B parameters or more. In other example, a generative model can include a language model having less than 10B parameters (e.g., 1B parameters). In yet another example, the generative model can include an autoregressive language model or an image diffusion model. As further examples, a generative model can include a machine-learned text-to-image model, a machine-learned text-to-video model, a machine-learned text-to-audio model, a machine-learned multi-modal model, or any other machine-learned model configured to provide generative content in response to a user query. The generative content generated by generative models 152 can include text data, image data, video data, audio data, or other types of generative content. The generative model can be trained to process input data to generate output data. The input data can include text data, image data, audio data, latent encoding data, and/or other input data, which may include multimodal data. The output data can include text data, image data, audio data, latent encoding data, and/or other input data.

Event analysis system 120 can be configured to automate the analysis of the impact of one or more target events on a target entity. The event analysis system 120 can use any of a variety of machine-learning systems including a machine learning system including one or more machine-learned generative models 152. Event analysis system 120 can implement a process flow for analyzing impact(s) of an event on an entity. The process flow can include sequentially accessing a set of machine-learned sequence processing models to generate hypotheses, formulate background research questions, conduct background research, quantitatively analyze findings, use quantitative projections to validate hypotheses, and synthesize the results.

Hypothesis generation system 122 is configured to generate one or more hypotheses based on an event and entity. Hypothesis generation system 122 can include or access one or more generative models 152 of a machine learning system to perform its analysis. Hypothesis generation system 122 can receive one or more inputs including an indication of the event and an indication of the target entity. In an example embodiment, hypothesis generation system can 122 receive a description of the event (e.g., from user input) and a description of the entity (e. g, retrieved by data retrieval system 130). Hypothesis generation system 122 can optionally receive an input relating to one or more focus areas of expertise. For example, the focus area input may identify one or more areas of interest, a point of view for the research (e.g., the title or job of the person directing the research), etc. Hypothesis generation system can generate one or more outputs including a list of hypothesis. Hypothesis generation system 122 can retrieve background data including information associated with the entity and generate one or more hypotheses based on the event and the retrieved background data. Hypothesis generation system 122 can access data retrieval system to cause data retrieval system 130 to retrieve data from one or more data sources. Processing the retrieved data, hypothesis generation system can analyze the retrieved data to generate one or more hypotheses regarding the impact of the event on the entity.

Question generation system 124 is configured to generate background data based on the event and hypotheses. Question generation system 124 can include or access one or more generative models 152 of machine learning system to perform its analysis. Question generation system 124 can receive one or more inputs including the hypotheses generated by hypothesis generation system 122. Question generation system 124 can also receive an indication of the event and/or an indication of the target entity. Question generation system 124 can generate one or more outputs including background data. In some examples, the question generation system 124 can first generate one or more evidence gathering questions and then use the evidence gathering questions to determine one or more grounded answers for the background data. Question generation system 124 can generate background data using data retrieved using data retrieval system 130.

Quantitative argumentation system 126 is configured to generate one or more quantitative argumentations or arguments based on the background data and one or more hypotheses. Quantitative argumentation system 126 can include or access one or more generative models 152 of machine learning system to perform its analysis. Quantitative argumentation system 126 can receive one or more inputs including the background data generated by question generation system 124. Quantitative argumentation system 126 can receive an indication of the event and/or an indication of the target entity. Quantitative argumentation system 126 can generate one or more outputs including argumentation data. The argumentation data can be used to increase the confidence that the hypotheses generated by hypothesis generation system 122 correctly indicate the impact of the event on the entity.

Conclusion synthesis system 128 is configured to synthesize one or more conclusions. Conclusion synthesis system 128 can include or access one or more generative models 152 of machine learning system to perform its analysis. Conclusion synthesis system 128 can receive one or more inputs including the hypotheses generated by hypothesis generation system 122 and the argumentation data generated by quantitative argumentation system 126. Conclusion synthesis system 128 can generate one or more outputs including one or more conclusions based on the received inputs. In some examples, the conclusion synthesis system 128 can also receive an indication of the event and/or an indication of the target entity. The conclusion synthesis system 128 can synthesize the hypotheses, the background data, and the quantitative argumentation data to produce a set of conclusions. For example, conclusion synthesis system 128 can use the hypotheses (e.g., the hypothesis list), the background data (e.g., facts about the entities and the impact of events), the argumentation data (e.g., quantitatively analyzed findings), and the outputs of the generative models 152 to generate one or more conclusions based on the input data.

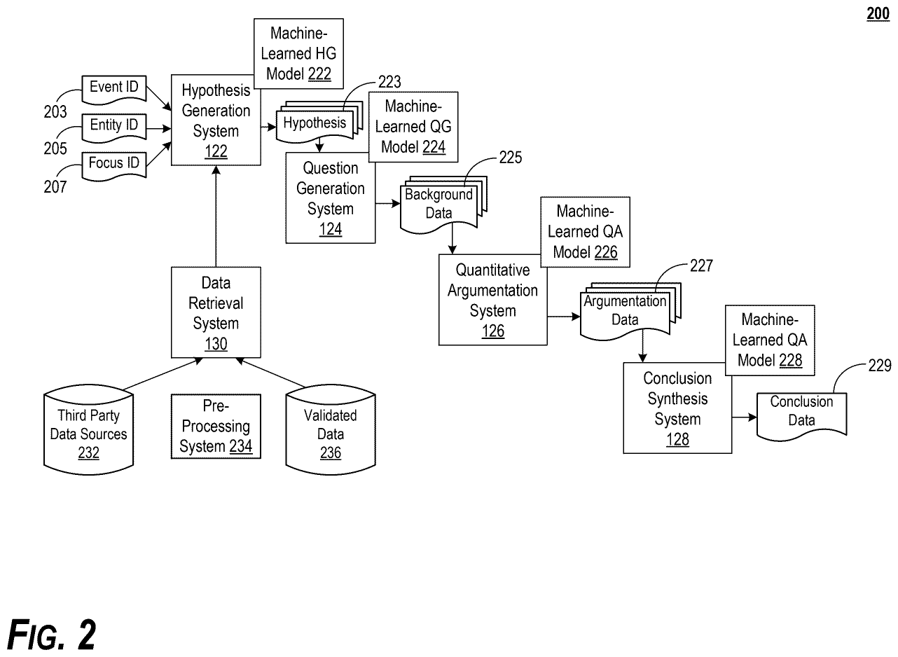

FIG. 2 depicts an example computing environment 200 including an event analysis system and an example data flow for analyzing an impact of an event of an entity using an example event analysis system. More particularly, FIG. 2 depicts details of an event analysis system including a machine-learned hypothesis generation system 122, a machine-learned question generation system 124, a machine-learned quantitative argumentation system 126, a machine-learned conclusion synthesis system 128, a data retrieval system 130. Event analysis system is configured to generate one or more hypotheses based on an event and entity, and generate one or more conclusions based on the one or more hypotheses, background data, and one or more argumentation processes.

In the depicted process flow, hypothesis generation system 122 receives one or more event identifications 203, one or more entity identifications 205, and one or more focus identifications 207. Hypothesis generation system can access data retrieval system 130 to retrieve data about the event, entity and/or focus based on the received input(s). Data retrieval system 130 can access one or more third party data sources 232 to retrieve background information. In some examples, the background information can undergo pre-processing 234 to generate validated data 236 which can be stored in one or more data storage devices accessible to the event analysis system. Hypothesis generation system 122 can generate one or more hypothesis 223 using one or more sequence processing models including a machine-learned hypothesis generation model 222.

Hypothesis generation model 222 can be trained to receive input data including event, entity, and focus identification information and generate an output including one or more hypotheses 223. Hypothesis generation model 222 can be trained using supervised fine tuning based on demonstrations of hypotheses generation. Training examples can be obtained from human written examples of analysis and/or model produced examples that are improved and filtered using a critique model. For example, a set of human demonstrations of hypotheses can be input to hypothesis generation model 222. Hypothesis generation model 222 can be trained to determine a relevance or other importance factor of an output hypothesis based on a degree of correlation between the output hypotheses and a training example provided hypothesis. Hypothesis generation model 222 can additionally be trained using reinforcement learning based on human feedback to hypothesis generation model 222. Reinforcement learning based on human feedback can be based on a rating scale that is designed to reflect the utility and quality of outputs generated by the hypothesis generation model for a corresponding task.

Question generation system 124 receives the hypotheses 223 and optionally the event and/or entity identifications and outputs background data 225. In some examples, the question generation system 124 can first generate one or more evidence gathering questions and then use the evidence gathering questions to determine one or more grounded answers for the background data. Question generation system 124 can generate background data using data retrieved using data retrieval system 130. Question generation system can include or otherwise access one or more machine-learned question generation models 224. In an example embodiment, question generation model 224 can receive an input including one or more hypotheses, a description of the event, and a description of the entity and generate a list of evidence gathering questions. The evidence gathering questions can then be provided to data retrieval system 130 to retrieve third party data and/or validated data including answers to the evidence gathering questions. In some examples, the evidence gathering questions can be provided as input to the question generation model which can access data retrieval system 130 to generate background data including answers to the evidence gathering questions.

Question generation model 224 can be trained to receive input data including hypotheses 223 and generate an output including background data 225. Question generation model 224 can be trained using supervised fine-tuning based on demonstrations of background research questions. Training examples can be obtained from human written examples of analysis and/or model produced examples that are improved and filtered using a critique model. For example, a set of human demonstrations of background research questions can be input to question generation model 224. Question generation model 224 can be trained to determine a relevance or other importance factor of output background data based on a degree of correlation between the output data and a training example provided background data. Question generation model 224 can additionally be trained using reinforcement learning based on human feedback to question generation model 224. Reinforcement learning based on human feedback can be based on a rating scale that is designed to reflect the utility and quality of outputs generated by the question generation model for a corresponding task.

Quantitative argumentation system 126 receives the background data 225, one or more hypotheses, and optionally the event and/or entity identifications and outputs argumentation data 227. The argumentation data 227 can be used to increase the confidence that the hypotheses generated by hypothesis generation system 122 correctly indicate the impact of the event on the entity. Argumentation data 227 can include quantitative projections generated using machine-learned quantitative argumentation model 226 to generate quantitative analysis of the hypotheses Quantity projections can indicate a level of confidence as to the validity of the hypotheses. Quantitative argumentation system 126 can include or otherwise access one or more machine-learned quantitative argumentation models 226.

The quantitative argumentation model 226 can be trained to receive input data (e.g., background data 225) and generate an output including argumentation data 227 including quantitative projections. Quantitative argumentation model 226 can be trained using supervised fine-tuning based on demonstrations of argumentation tasks. Training examples can be obtained from human written examples of analysis and/or model produced examples that are improved and filtered using a critique model. For example, a set of human demonstrations of argumentation tasks can be input to quantitative argumentation model 226. Quantitative argumentation model 226 can be trained to determine a relevance or other importance factor of an output argumentation data based on a degree of correlation between the output argumentation data and a training example provided argumentation data. Quantitative argumentation model 226 can additionally be trained using reinforcement learning based on human feedback to quantitative argumentation model 226. Reinforcement learning based on human feedback can be based on a rating scale that is designed to reflect the utility and quality of outputs generated by the quantitative argumentation model for a corresponding task.

Conclusion synthesis system 128 receives the hypotheses 223 and optionally the event and/or entity identifications and the argumentation data 227 and outputs one or more conclusions 229. The conclusion synthesis system 128 can synthesize the hypotheses, the background data, and the argumentation data to produce a set of conclusions. For example, conclusion synthesis system 128 can use the hypotheses (e.g., the hypothesis list), the background data (e.g., facts about the entities and the impact of events), and the argumentation data (e.g., quantitatively analyzed findings), to generate one or more conclusions 229 based on the input data. Conclusion synthesis system 128 can include or otherwise access a machine-learned synthesis model 228.

The synthesis model 228 can be trained to receive input data (e.g., hypotheses 223, background data 225, and argumentation data 227) and generate an output including report data 229 having one or more conclusions. Synthesis model 228 can be trained using supervised fine-tuning based on demonstrations of conclusion synthesis. Training examples can be obtained from human written examples of analysis and/or model produced examples that are improved and filtered using a critique model. For example, a set of human demonstrations of conclusion synthesis can be input to synthesis model 228. Synthesis model 228 can be trained to determine a relevance or other importance factor of an output conclusion based on a degree of correlation between the output conclusion and a training example provided conclusion. Synthesis model 228 can additionally be trained using reinforcement learning based on human feedback to synthesis model 228. Reinforcement learning based on human feedback can be based on a rating scale that is designed to reflect the utility and quality of outputs generated by the synthesis model for a corresponding task.

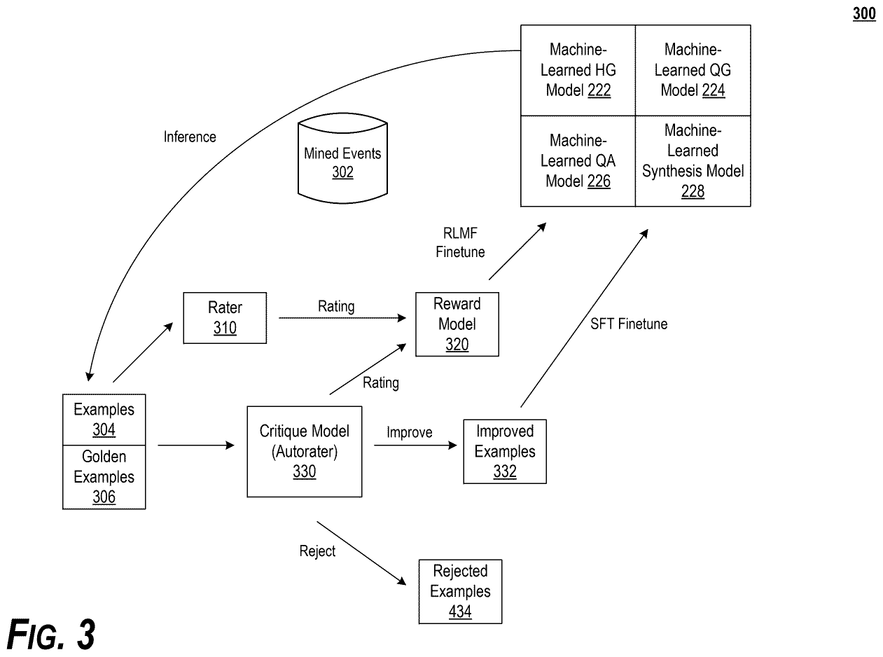

FIG. 3 is a block diagram depicting an example computing environment including training of a machine learning system according to example embodiments of the present disclosure. A compact and smaller version of a larger LLM can be generated to serve traffic efficiently and in a manner to reduce usage of computing resources. A model can be distilled from a LLM in example embodiments.

Specialized models such as machine-learned hypothesis generation model 222, machine-learned question generation model 224, machine-learned quantitative argumentation model 226, and machine-learned synthesis model 228 can be trained for their specific tasks. The models can be trained based on textual inputs (e.g., event and entity identification) and outputs (e.g., argumentation of a hypothesis). Supervised fine tuning (SFT) can be used to train the models on the demonstrations of quality examples of input and output. Training examples can be obtained from human written examples of model's performance and/or model produced examples that are improved and filtered using a critique model. Prompt variation can be used to train the model using a large number of examples, while ensuring each example is sufficiently diverse such that the model can generalize to new data. In example embodiments, low rank adaptation of large language models can be used (LoRa). A main model (e.g., synthesis model) can act as an agent planner.

A critique model 330 can be used as an autorater, with the added functionality of applying criticisms to the outputs of the machine-learned synthesis model 228. The critique model 330 can provide feedback to the synthesis model 228 which can adapt its internal representations to match a ground truth. The system can critique and modify all parts of the output to improve and normalize training examples. The system can generate structured ratings (i.e., critiques) of the arguments using a rating template. The rating can be used to modify the text of the original hypotheses, questions, and/or arguments. The improved examples can be used in supervised fine tuning of the model. The samples that cannot be sufficiently improved are rejected and excluded from the training mixture for the next training epoch. Ratings can be used to apply RLHF to the main model.

The set of machine-learned models includes machine-learned hypothesis generation model 222, machine-learned question generation model 224, machine-learned quantitative argumentation model 226, and machine-learned synthesis model 228. One or more of the models can generate an inference based on one or more mined events 302. The inference(s) can be used to generate training examples 304 and golden training examples 306. The training examples can be provided to a rater 310 (e.g., human rater) that can generate a rating which is provided to a reward model 320. The training examples can also be provided to a critique model 330 (autorater). The critique model can also generate a rating based on each example which is provided to reward model 320. Reward model 320 uses the human provided rating and/or the critique model ratings to perform reinforcement learning from human feedback to train models 222, 224, 226, and/or 228. Critique model 330 also determines whether to improve a training example or reject a training example. Improved training examples 332 are provided to train models 222, 224, 226, and/or 228 using supervised fine tuning.

### Example Methods

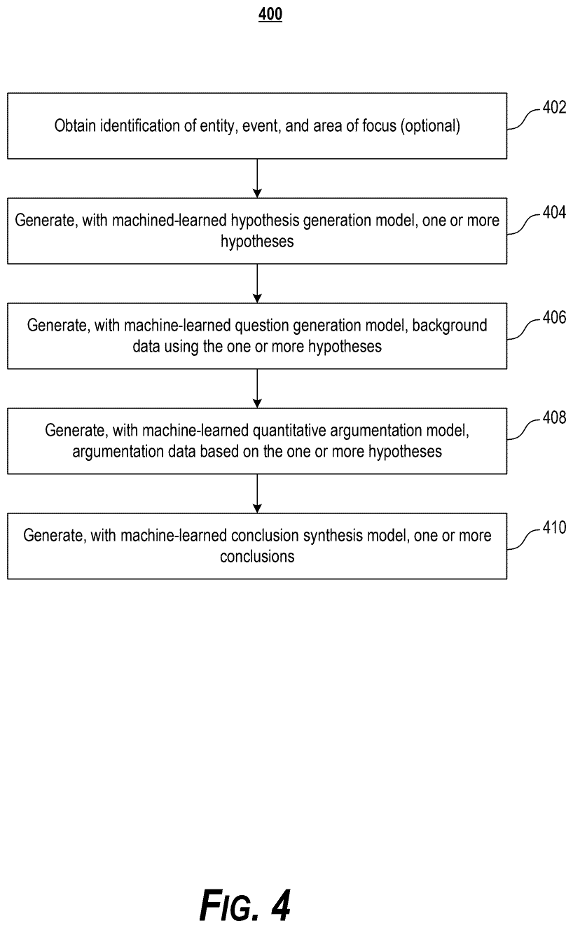

FIG. 4 is a flowchart diagram depicting an example method for analyzing the impact of an event on an entity, according to example embodiments of the present disclosure.
One or more portion(s) of example method 400 and the other methods described herein can be implemented by a computing system that includes one or more computing devices such as, for example, computing systems described with reference to FIG. 1 and FIG. 2. Each respective portion of the example methods can be performed by any (or any combination) of one or more computing devices. Moreover, one or more portion(s) of the example methods 400 can be implemented on the hardware components of the device(s) described herein, for example, to moderate content produced by one or more generative models. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and is not meant to be limiting. One or more portions of the example methods can be performed additionally, or alternatively, by other systems.

At 402, method 400 can include obtaining an identification of an entity, an event, and optionally, an area of focus. For example, hypothesis generation system 122 can receive one or more event identifications, one or more entity identifications, and optionally one or more focus identifications.

At 404, method 400 can include generating one or more hypotheses. For example, hypothesis generation system 122 can generate one or more hypotheses 223 using one or more sequence processing models including a machine-learned hypothesis generation model 222. The hypothesis generation model 222 can be trained to receive input data including the event, the entity, and/or focus and generate an output including one or more hypotheses 223. In some examples, the system can retrieve data about the entity and the event that can be used to generate one or more hypotheses.

At 406, method 400 can include generating background data based at least in part on the one or more hypotheses. For example, question generation system 124 can receive the hypotheses 223 and optionally the event and/or entity identifications and output background data 225. Question generation system 124 can include or otherwise access one or more machine-learned question generation models 224. The question generation model 224 can be trained to receive input data including hypotheses 223 and generate an output including background data 225. In example embodiments, question generation model 224 can receive an input including one or more hypotheses, a description of the event, and a description of the entity and generate a list of evidence gathering questions. The evidence gathering questions can then be provided to data retrieval system 130 to retrieve third party data and/or validated data including answers to the evidence gathering questions. In some examples, the evidence gathering questions can be provided as input to the question generation model which can access data retrieval system 130 to generate background data including answers to the evidence gathering questions.

At 408, method 400 can include generating argumentation data based on the hypotheses. In an example embodiments, one or more hypotheses and background data can be provided as input to a machine-learned argumentation model. The machine-learned argumentation model can perform quantitative analysis using hypotheses and the background data. For example, quantitative argumentation system 126 can receive the background data 225 and optionally the event and/or entity identifications and output argumentation data 227. The argumentation data 227 can be used to increase the confidence that the hypotheses generated by hypothesis generation system 122 correctly indicate the impact of the event on the entity. Quantitative argumentation system 126 can include or otherwise access one or more machine-learned quantitative argumentation models 226. The quantitative argumentation model 226 can be trained to receive input data (e.g., background data 225) and generate an output including argumentation data 227 including quantitative projections. Quantitative argumentation data 227 can include quantitative projections generated using machine-learned quantitative argumentation model 226 to generate quantitative analysis of the hypotheses. Quantity projections can indicate a level of confidence as to the validity of the hypotheses.

At 410, method 400 can include generating one or more conclusions. For example, conclusion synthesis system 128 can receive the hypotheses 223 and optionally the event and/or entity identifications and the argumentation data 227 and output one or more conclusions 229. The conclusion synthesis system 128 can synthesize the hypotheses, the background data, and the argumentation data to produce a set of conclusions. For example, conclusion synthesis system 128 can use the hypotheses (e.g., the hypothesis list), the background data (e.g., facts about the entities and the impact of events), and the argumentation data (e.g., quantitatively analyzed findings), to generate one or more conclusions 229 based on the input data. Conclusion synthesis system 128 can include or otherwise access a machine-learned synthesis model 228. The synthesis model 228 can be trained to receive input data (e.g., hypotheses 223, background data 225, and argumentation data 227) and generate an output including report data 229 having one or more conclusions.

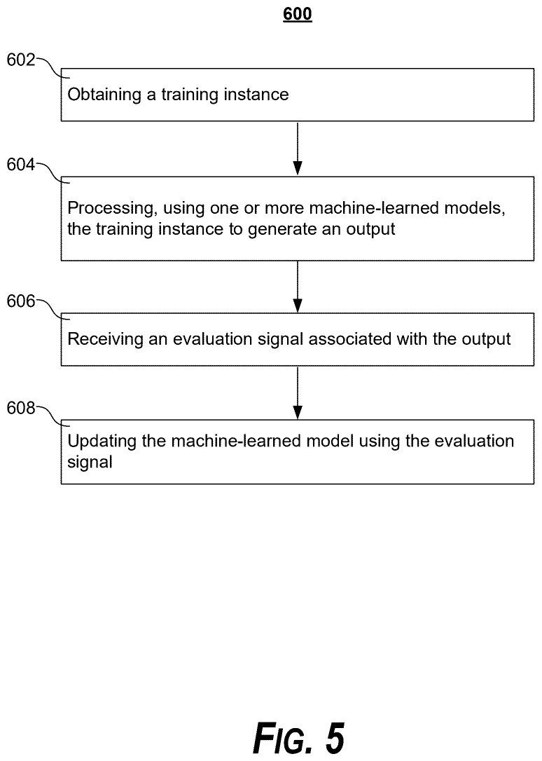

FIG. 5 depicts a flowchart of a method 500 for training one or more machine-learned models according to aspects of the present disclosure. For instance, an example machine-learned model can include a core sequence processing model such as a foundational large language model (LLM).

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 67 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

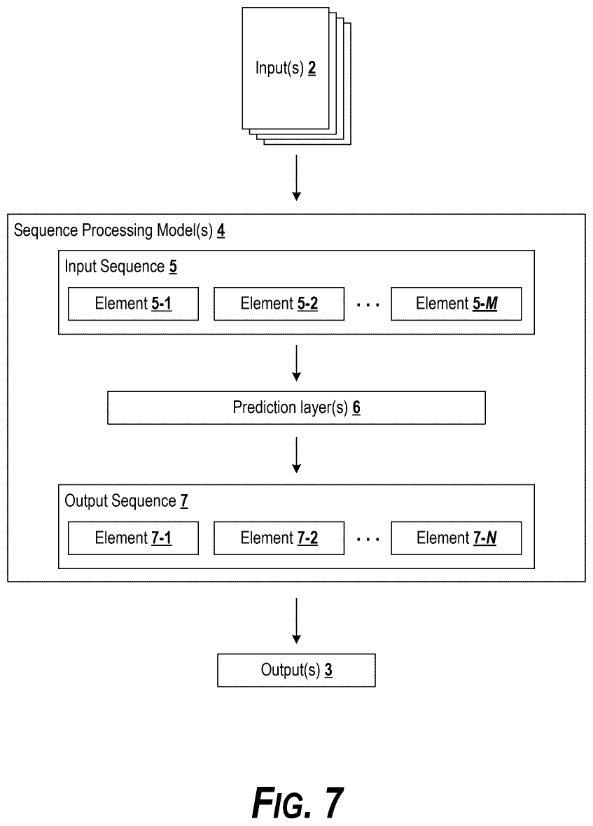

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

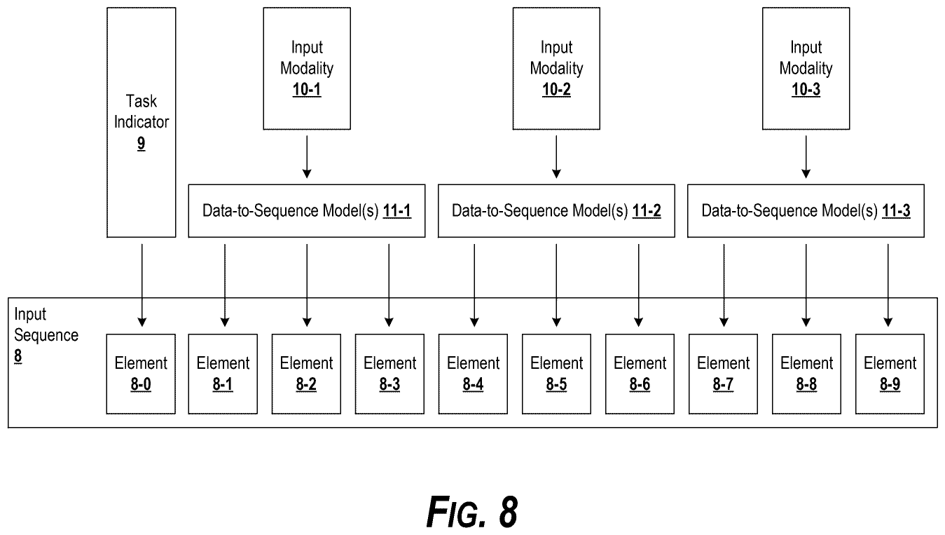

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0,. 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-learned Model Development Platform

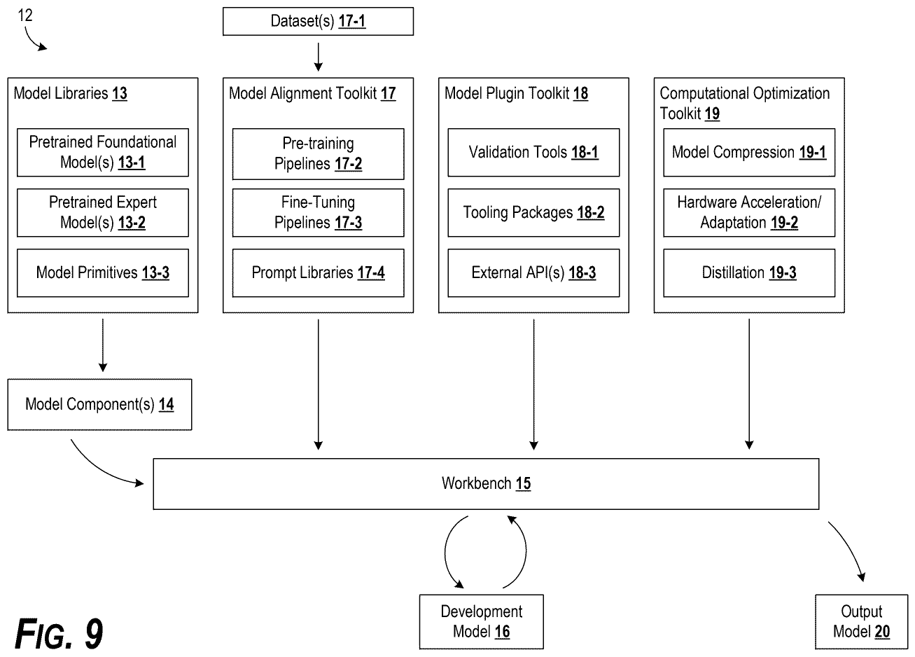

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

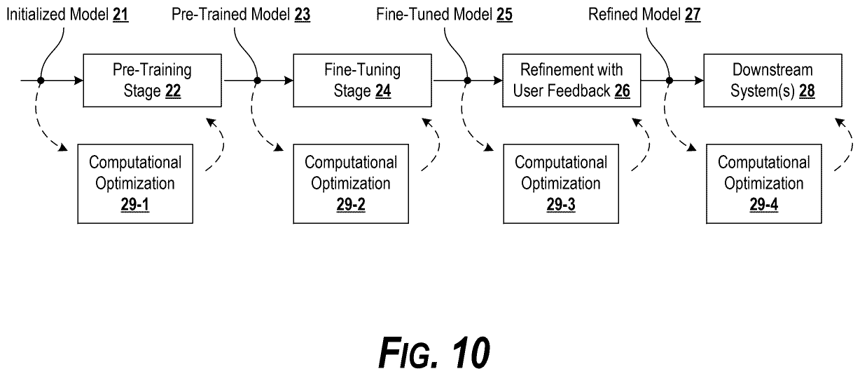

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

### Example Machine-Learned Model Inference System

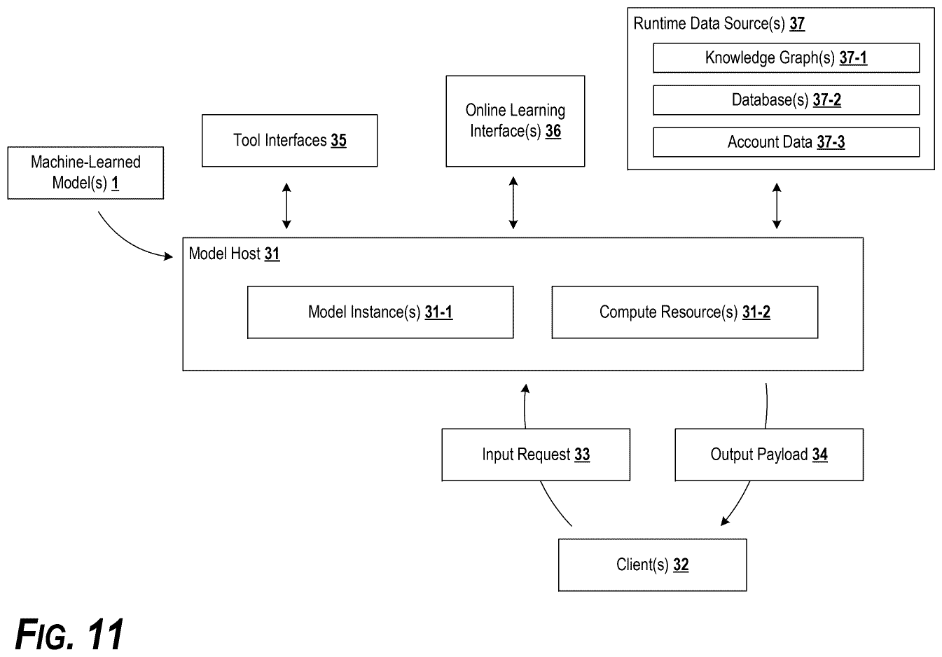

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

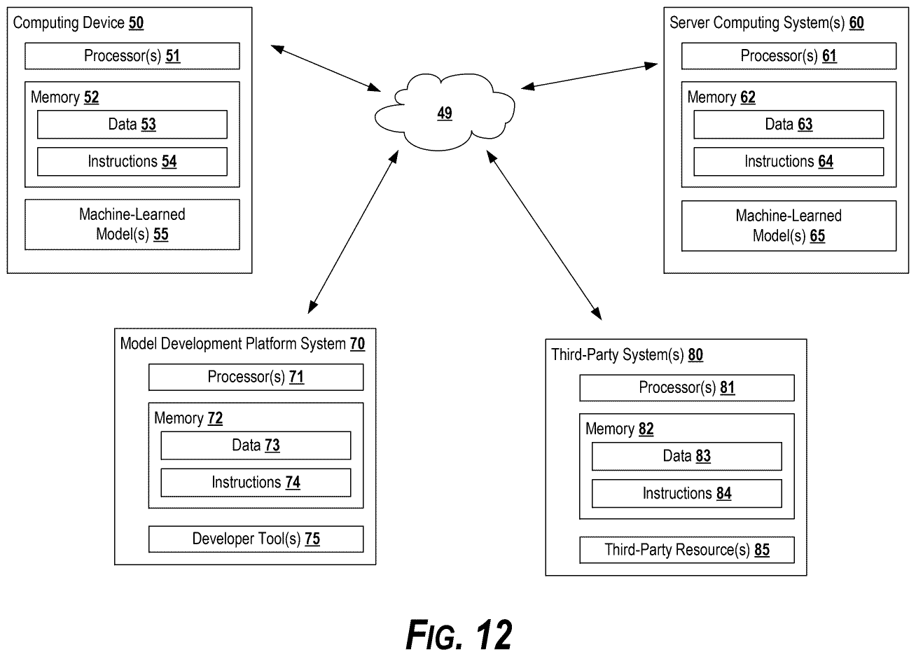

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

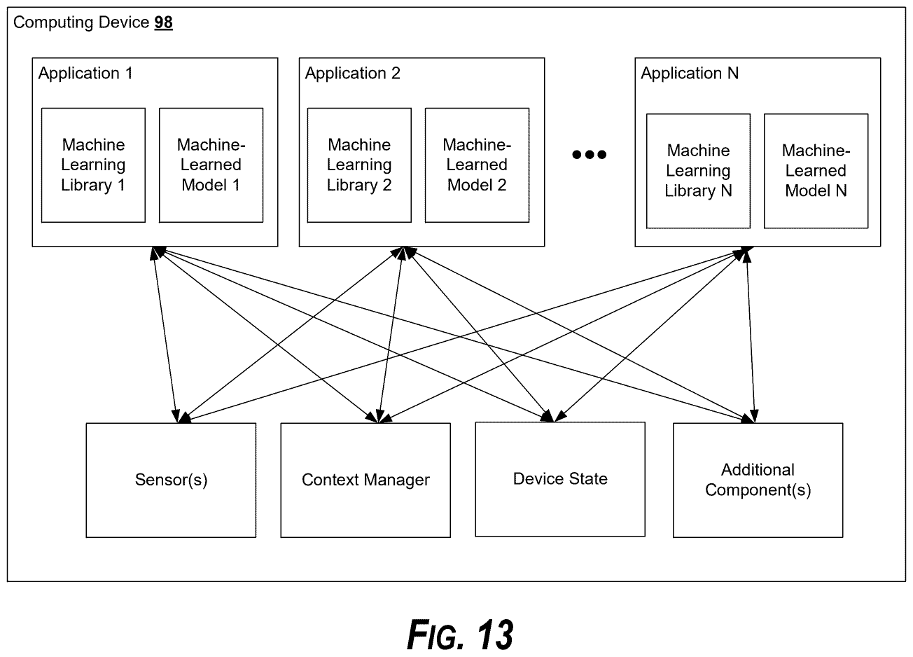

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

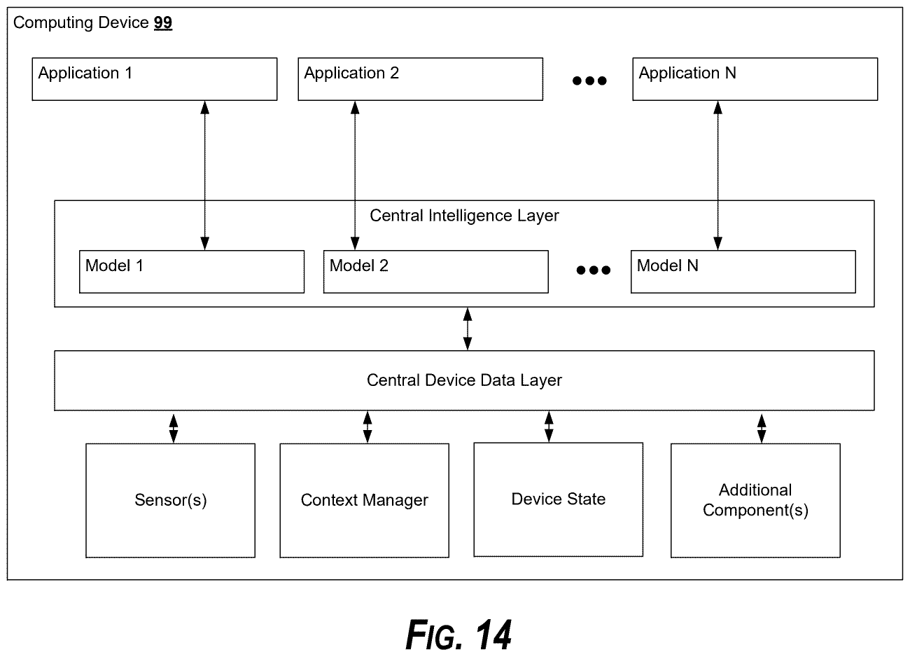

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for using machine learning to automate and improve event impact analysis, the method comprising:
generating, with a machine-learned hypothesis generation model and based on at least one input including an indication of an event and retrieved background information associated with an entity, hypothesis data based on a pairing of the event and the entity;
generating, with a machine-learned question generation model and based on at least one input including the indication of the event and the hypothesis data, background data associated with proof of at least one hypotheses;
generating, with a machine-learned quantitative argumentation model, argumentation data based at least in part on the background data; and
generating, with a machine-learned conclusion synthesis model and based on the at least one hypotheses, the background data, and the argumentation data, conclusion data including a representation of an analysis of an impact of the event on the entity.

2. The computer-implemented method of claim 1, wherein:
the argumentation data includes one or more quantitative projections.

3. The computer-implemented method of claim 2, further comprising:
identifying the at least one hypotheses as a most likely hypothesis based on the one or more quantitative projections.

4. The computer-implemented method of claim 1, further comprising:
training the machine-learned hypothesis generation model using at least one of supervised fine-tuning or reinforcement learning from human feedback.

5. The computer-implemented method of claim 4, wherein:
training the machine-learned hypothesis generation model includes training with training data that includes demonstrations of hypothesis generation based on the event.

6. The computer-implemented method of claim 1, further comprising:
training the machine-learned question generation model using at least one of supervised fine-tuning or reinforcement learning from human feedback.

7. The computer-implemented method of claim 6, wherein:
training the machine-learned question generation model includes training with training data that includes demonstrations of background research questions based on the event and the hypotheses.

8. The computer-implemented method of claim 1, further comprising:
training the machine-learned quantitative argumentation model using at least one of supervised fine-tuning or reinforcement learning from human feedback.

9. The computer-implemented method of claim 8, wherein:
training the machine-learned quantitative argumentation model includes training with training data that includes demonstrations of argumentation tasks based on the background data.

10. The computer-implemented method of claim 1, further comprising:
training the machine-learned conclusion synthesis model using at least one of supervised fine-tuning or reinforcement learning from human feedback.

11. The computer-implemented method of claim 10, wherein:
training the machine-learned conclusion synthesis model includes training with training data that includes demonstrations of conclusion synthesis based on at least one of the hypotheses, the background data, and the argumentation data.

12. The computer-implemented method of claim 1, further comprising:
training the machine-learned hypothesis generation model, the machine-learned question generation model, the machine-learned quantitative argumentation model, and the machine-learned conclusion synthesis model using unsupervised pre-training and fine-tuning.

13. A system, comprising:
a machine-learned hypothesis generation model configured to generate hypothesis data based at least in part on an indication of an event;
a machine-learned question generation model configured to generate background data based at least in part on an indication of the event and the hypothesis data;
a machine-learned quantitative argumentation model configured to generate argumentation data based at least in part on the background data and at least one hypotheses; and
a machine-learned synthesis model configured to synthesize the at least one hypotheses, the background data, and the argumentation data into at least one conclusion of an impact of the event.

14. The system of claim 13, wherein:
the machine-learned hypothesis generation model is trained using supervised fine-tuning (SFT) with training data that includes demonstrations of hypothesis generation based on the event.

15. The system of claim 13, wherein:
the machine-learned question generation model is trained using SFT with training data that includes demonstrations of background research based on the event.

16. The system of claim 13, wherein:
the machine-learned quantitative argumentation model is trained using SFT with training data that includes demonstrations of argumentation using quantitative projections based on background data.

17. The system of claim 13, wherein:
the machine-learned synthesis model is trained using SFT with training data comprising input-output pairs, an input of each input-output pair including a hypothesis example, a background example, and a argumentation example, an output of each input-output pair including a synthesized conclusion example of an example impact of an example event on an example entity.

18. The system of claim 13, wherein:
the machine-learned hypothesis generation model is configured to generate the hypothesis data based on the indication of the event and retrieved background information.

19. The system of claim 13, wherein:
the machine-learned question generation model is configured to generate the background data based on the indication of the event and retrieved background information.

20. The system of claim 13, wherein:
the machine-learned synthesis model includes a sequence processing model.
